(19) United States
(12) Patent Application Publication
(10) Pub. No.: US 2006/0037986 A1
(43) Pub. Date: Feb. 23, 2006

(54) Pivotable mechanism for bicycle racks

(76) Inventor: Chiu-Kuei Wang, Miao-Lih Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/919,246

(22) Filed: Aug. 17, 2004

(51) Int. Cl. B60R 11/00

(52) U.S. Cl. 224/521; 224/924

(57) ABSTRACT

A bicycle rack includes an upright tube pivotably embraced by an embracing member on the hitch by a pin and a stop member is movably connected to the upright tube. The stop member is connected to a cable which has a handle for convenience of pulling by the user. The lower end of the stop member is movably between a lock position where the lower end is located below the top edge of the embracing member, and an open position where the lower end is located above the top edge of the embracing member. The upright tube can be pivoted about the pin when the stop member is pulled to its open position.

### FIELD OF THE INVENTION

The present invention relates to a bicycle rack having a pivotable mechanism which allows the user to easily pivot the upright rod when opening back hatch of vehicles.

### BACKGROUND OF THE INVENTION

A conventional bicycle rack connected to rear end of vehicles is disclosed in FIGS. 6 and 7, and generally includes a connection mechanism 70 which connects the bicycle rack 80 to the hitch 60 connected to the rear end of vehicles. The hitch 60 includes a sphere 61 and the connection mechanism 70 includes a retaining portion 72 which has a holding member 75 and an upright rod 81 of the rack 80 is pivotably connected to the holding member 75 at an end of the connection mechanism 70 by a pin 76 and the sphere 61 is retained in the retaining portion 72. A pressing board 74 presses onto the sphere 61 and a lever 741 is pivoted to force the pressing board 74 to securely connect the retaining portion 72 to the sphere 61. An L-shaped tube 82 has one end inserted in the upright tube 81 and the other end of the L-shaped tube 82 has a plurality of clamping units for securing the bicycle frames. A bolt 83 extends through the upright tube 81 and the holding member 75 and includes a hook end 830 which is hooked on the holding member 75 such that the upright tube 81 cannot be pivoted counter clockwise about the pin 77. A spring 84 is hooked between the bolt 83 and a lower open end of the holding member 75 so as to keep the bolt 83 at a position as shown in FIG. 7. A cable 85 is connected to the pin 77 and can be pulled to lift the bolt 83 to disengage the hook end 830 from the holding member 75, such that the upright tube 81 can be pivoted about the pin 77.

Obviously, the conventional connection mechanism 70 is a complicated mechanism an includes too many movable parts which could be tangled or operated unintentionally to release the locking feature. Besides, it is difficult to evenly lift the bolt 83 and the friction between the hook end 830 and the holding member 75 can be so huge that the bolt 83 cannot be easily lifted.

The present invention intends to provide a pivotable mechanism for a bicycle rack and the user simply pulls a cable to release the lock status and the rack can be easily pivoted.

### SUMMARY OF THE INVENTION

The present invention relates to bicycle rack that comprises an upright tube pivotably connected to an embracing member of the hitch and the embracing member has an open side so that the upright tube can be pivoted through the open side. A stop member is movably connected to the upright tube and a lower end of the stop member is movable between a lock position where the lower end of the stop member is located below a top edge of the embracing member, and an open position where the lower end of the stop member is located above the top edge of the embracing member. An L-shaped tube is connected to the upright tube and a plurality of clamping units are connected to the L-shaped tube so as to secure bicycles on the L-shaped tube. A cable has a first end connected to the stop member so as to pulled the stop member to let the lower end of the stop member move between the lock position and the open position.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle rack of the present invention;

FIG. 2 is an exploded view to show the bicycle rack of the present invention;

FIG. 3 is a cross sectional view to show the bicycle rack of the present invention;

FIG. 4A is a cross sectional view to show that the stop member is lifted by pulling the cable;

FIG. 4B shows the upright tube is pivoted;

FIG. 5 shows the bicycle rack is connected to a vehicle and a bicycle is secured to the bicycle rack of the present invention;

FIG. 6 shows a conventional bicycle rack, and

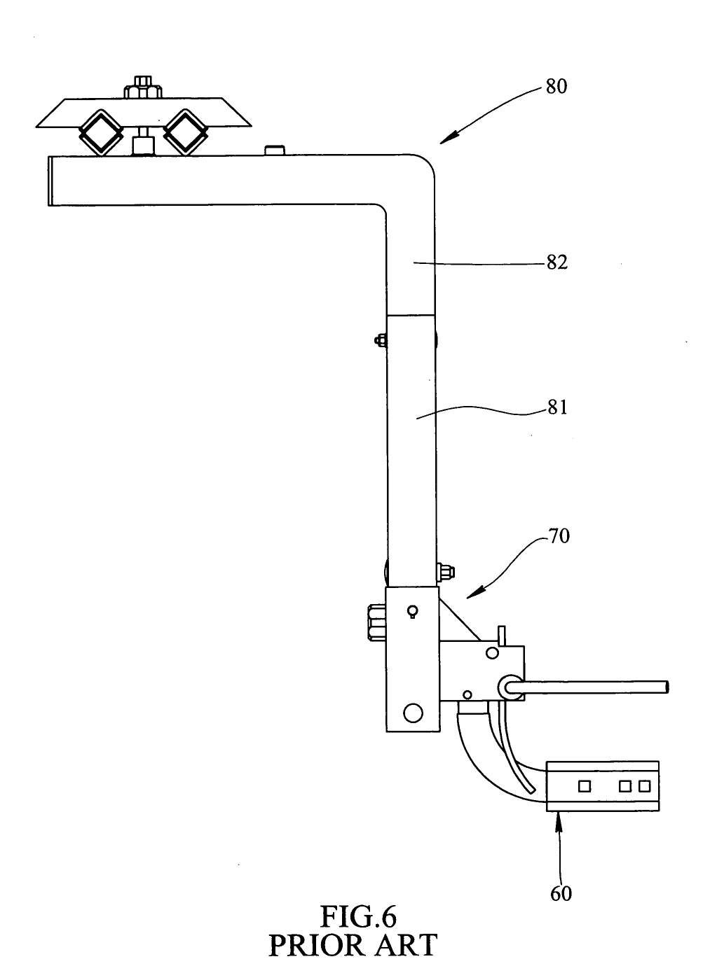

FIG. 7 shows a cross sectional view of the conventional bicycle rack.

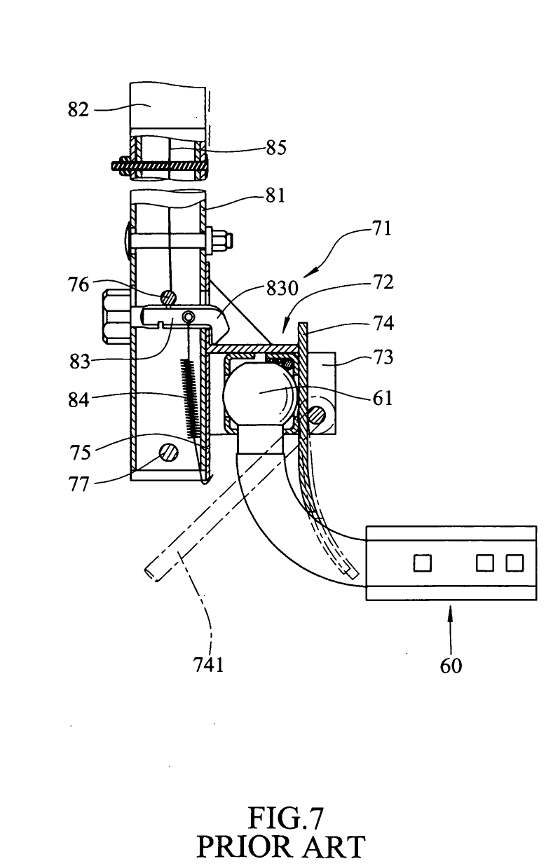

### DETAILED DESCRIPTION OF THE PREFERRED EMBODIMENT

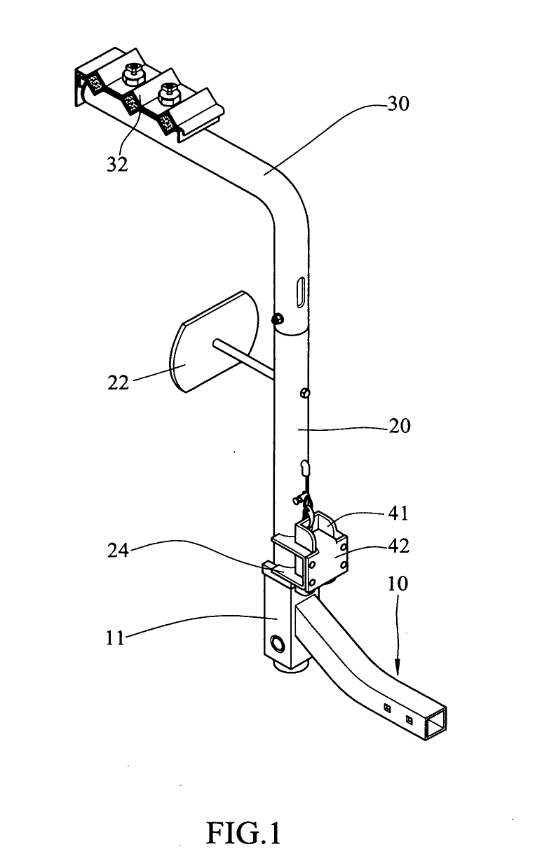

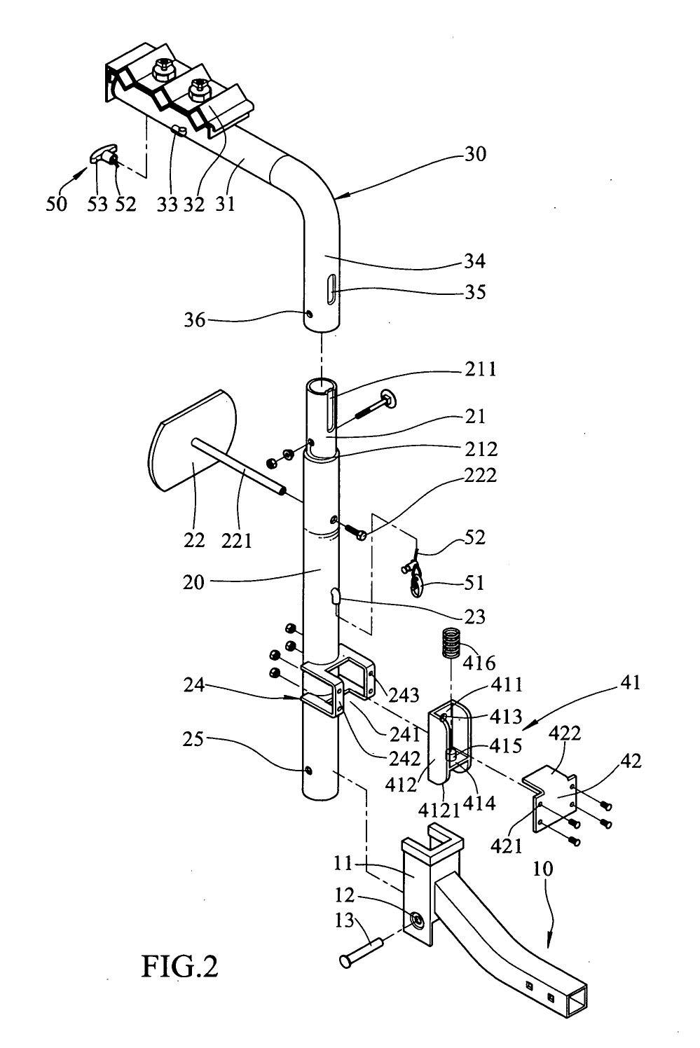

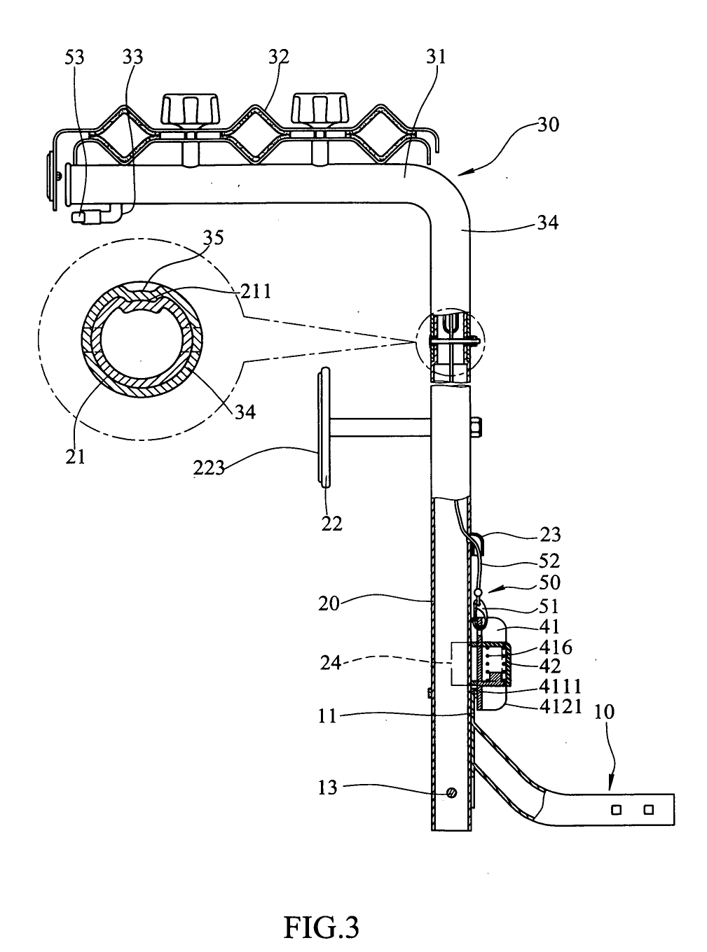

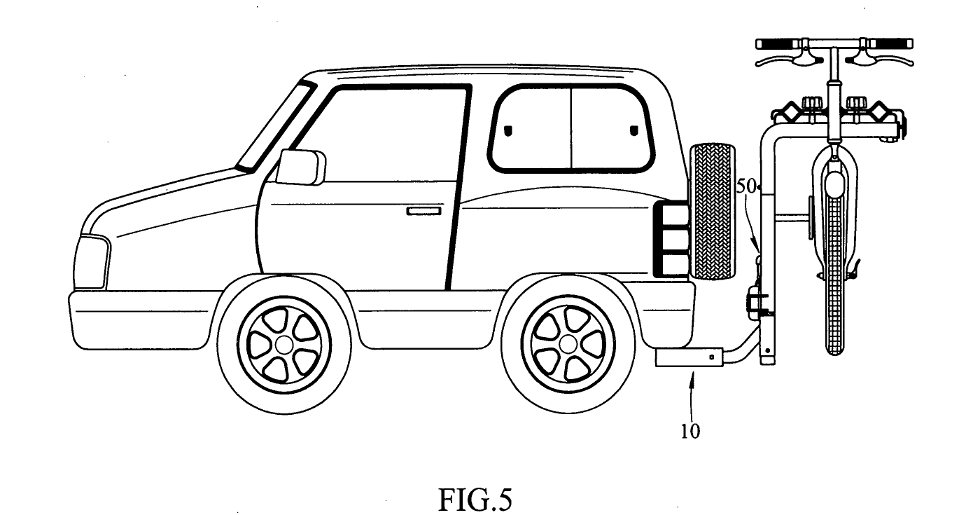

Referring to FIGS. 1 to 3, the bicycle rack of the present invention comprises a hitch unit 10 connected to a vehicle as disclosed in FIG. 5 and an embracing member 11 having an open side is connected at an end of the hitch unit 10. An upright tube 20 has a first end pivotably embraced by the embracing member 11 by extending a pin 13 through holes 12 in the embracing member 11 and a hole 25 in the upright tube 20. A U-shaped frame 24 is connected to the upright tube 20 and a space 241 is defined between two protrusions 242 of the U-shaped frame 24. A stop member 41 is movably received in the space 241 and includes a plate 411 with two sidewalls 412 extending from two sides of the plate 411. A transverse plate 414 is connected between the two sidewalls 412 and a positioning boss 415 extends from a top of the transverse plate 414. A positioning member 42 is fixed to the two protrusions 243 of the U-shaped frame 24 by screws extending through holes 421 in the positioning member 42 and threadedly connected to threaded holes 243 in the two protrusions 242 of the U-shaped frame 24. A spring 416 is biased between the horizontal plate 422 and the transverse plate 414. By the arrangement, the stop member 41 can only be moved up and down in the space 241 between the two protrusions 243 of the U-shaped frame 24. An L-shaped tube 30 is composed of a horizontal section 31 and an upright section 34, and a plurality of clamping units 32 are connected to a the horizontal section 31. A first end of the L-shaped tube 30 is connected to a second end 21 of the upright tube 20 and the clamping units 32 are able to clamp bicycles between an upper plate and a lower plate thereof.

A recess 211 is defined in an outer periphery of the second end 21 of the upright tube 20 and a ridge 35 extends inward from an inner periphery of the first end of the L-shaped tube 30. The first end of the L-shaped tube 30 is mounted to the second end 21 of the upright tube 20 and the ridge 35 engaged with the recess 211. A bolt extends through holes 36 in the first end of the L-shaped tube 30 and holes in the second end 21 of the upright tube 20.

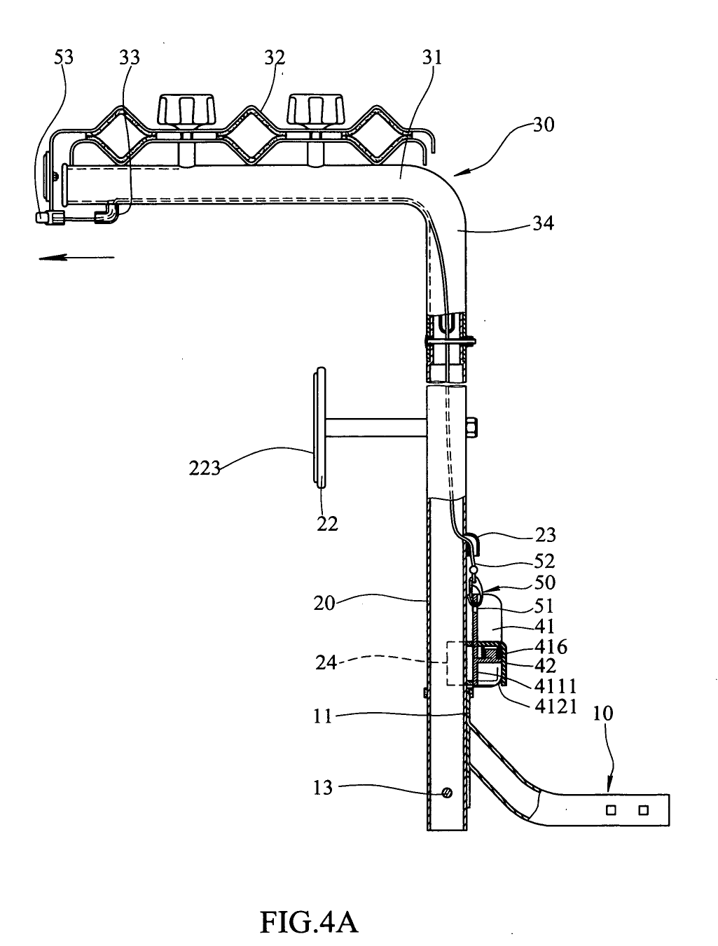

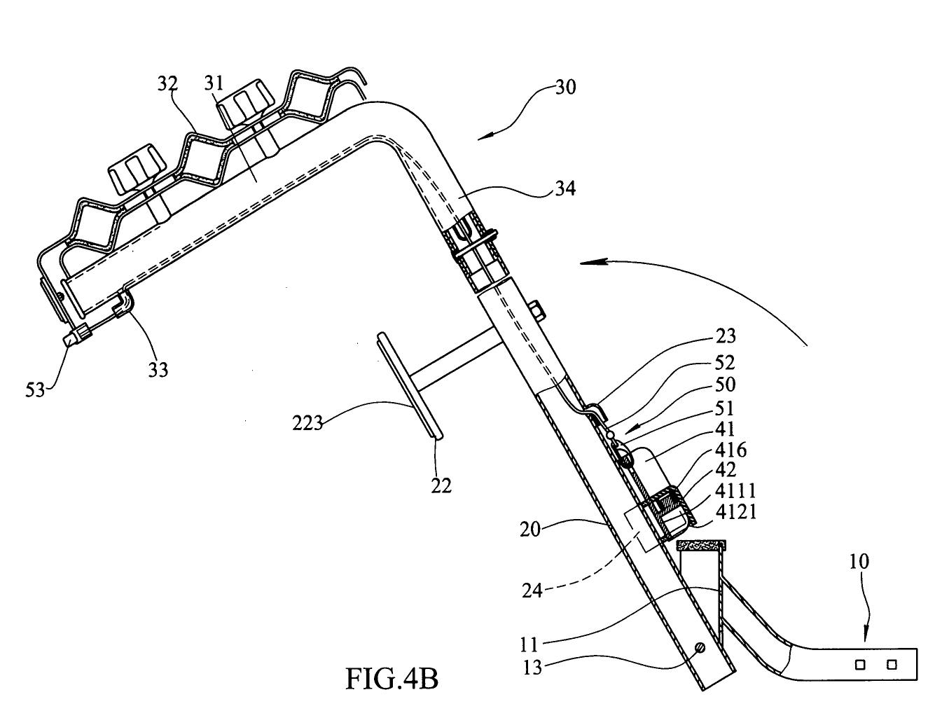

A pull unit 50 includes a cable 52 which is received in the upright tube 20 and the L-shaped tube 30. The first end of the cable 52 extends through a wall of the upright tube 20 and a guide tube 23 on the upright tube 20, a second end of the cable 52 extends through a wall of the L-shaped tube 30 and another guide tube 33 on the L-shaped tube 30. A handle 53 is connected to the second end of the cable 52. A hook member 51 is connected to the first end of the cable 52 and hooks to a hole 413 defined through the plate 411 of the stop member 41. Referring to FIGS. 4A and 4B, the stop member 41 can be pulled such that a lower end including the lower end of the plate 411 and lower ends 4121 of the sidewalls 412 of the stop member 41 is movable between a lock position where the lower end of the stop member 41 is located below a top edge of the embracing member 11, and an open position where the lower end of the stop member 41 is located above the top edge of the embracing member 11. When the stop member 41 is lifted, the upright tube 20 can be pivoted as shown in FIG. 4B.

A support rod 221 is perpendicularly connected to the upright tube 20 by using a long screw 222 extending through the upright tube 20 and connected to the support rod 221. A pad 22 with a soft outside is connected to the support rod 221 and 22 located beneath a horizontal section 31 of the L-shaped tube 30. As shown in FIG. 5, the pad 22 is in contact with the bicycle beneath the horizontal section 31 to prevent the bicycle from shaking or swing.

While we have shown and described the embodiment in accordance with the present invention, it should be clear to those skilled in the art that further embodiments may be made without departing from the scope of the present invention.

What is claimed is:

1. A bicycle rack comprising:
a hitch unit having an embracing member at an end thereof and the embracing member having an open side;
an upright tube having a first end pivotably embraced by the embracing member and a stop member movably connected to the upright tube and a lower end of the stop member movable between a lock position where the lower end of the stop member is located below a top edge of the embracing member, and an open position where the lower end of the stop member is located above the top edge of the embracing member, an L-shaped tube having a first end connected to a second end of the upright tube and a plurality of clamping units connected to a second end of the L-shaped tube, and
a cable having a first end connected to the stop member so as to pull the stop member to let the lower end of the stop member move between the lock position and the open position.

2. The bicycle rack as claimed in claim 1, wherein a U-shaped frame is connected to the upright tube and a space is defined between two protrusions, a stop member received in the space and including a plate with two sidewalls extending from two sides of the plate, a transverse plate connected between the two sidewalls, a positioning member connected to the two protrusions of the U-shaped frame and retaining the stop member between the two protrusions of the U-shaped frame, the positioning member having a horizontal plate and a spring biased between the horizontal plate and the transverse plate.

3. The bicycle rack as claimed in claim 1, wherein the cable is received in the upright tube and the L-shaped tube, the first end of the cable extending through a wall of the upright tube and a second end of the cable extending through a wall of the L-shaped tube, a handle connected to the second end of the cable.

4. The bicycle rack as claimed in claim 1, wherein a support rod is perpendicularly connected to the upright tube and a pad is connected to the support rod, the pad located beneath a horizontal section of the L-shaped tube.

5. The bicycle rack as claimed in claim 1, wherein a recess is defined in an outer periphery of the second end of the upright tube and a ridge extends inward from an inner periphery of the first end of the L-shaped tube, the first end of the L-shaped tube mounted to the second end of the upright tube and the ridge engaged with the recess.
